(19) United States
(12) Patent Application Publication
(10) Pub. No.: US 2013/0293632 A1
(43) Pub. Date: Nov. 7, 2013

(54) Cleaning a Nozzle Plate Having a Non-Wetting Layer

(71) Applicants: Christoph Menzel, New London, NH (US); Deane A. Gardner, Cupertino, CA (US)

(72) Inventors: Christoph Menzel, New London, NH (US); Deane A. Gardner, Cupertino, CA (US)

(21) Appl. No.: 13/461,534

(22) Filed: May 1, 2012

(51) Int. Cl. B41J 2/165

(52) U.S. Cl. 347/28

(57) ABSTRACT

A method for cleaning a nozzle plate includes applying a first solution to a surface of the nozzle plate, and applying a second solution different from the first solution to the surface of nozzle plate to remove the first solution from the surface of nozzle plate. The first solution wets the nozzle plate and is a solvent to dried ink deposited on the surface of the nozzle plate. The surface of the nozzle plate is non-wetting to the second solution.

### TECHNICAL FIELD

This description relates to cleaning a nozzle plate having a non-wetting layer.

### BACKGROUND

A fluid ejector (e.g., an ink jet printhead) typically has an interior surface, an orifice through which fluid is ejected, and an exterior surface. When fluid is ejected from the orifice, the fluid can accumulate on the exterior surface of the fluid ejector. This fluid can dry, creating debris. When fluid or debris accumulates on the exterior surface adjacent to the orifice, further fluid ejected from the orifice can be diverted from an intended path of travel or blocked entirely by interaction with the accumulated fluid (e.g., due to surface tension).

Some materials from which fluid ejectors are fabricated (e.g., silicon) are hydrophilic, which typically exacerbates the problem of accumulation when fluids are ejected. A non-wetting coating can coat the exterior surface of the fluid ejector.

### SUMMARY

A cleaning fluid can be applied to an exposed face of a fluid ejector to loosen debris, e.g., by rehydrating dried ink. This can be done in conjunction with mechanical wiping in order to remove both the debris and the cleaning fluid. However, one problem is that wiping the nozzle plate can introduce errors into the jetting direction and can damage the non-wetting coating. Without be limited to any particular theory, the cleaning fluid is wetting to the non-wetting coating in order to adhere to the surface and loosen the debris, and the wiping must be sufficiently forceful to remove the cleaning fluid, which can damage to the non-wetting coating. At least some of these problems can be alleviated by applying a high surface energy rinsing fluid that will mix with the cleaning fluid. By making the mixture non-wetting to the non-wetting coating after the debris has been loosened or dissolved, mechanical wiping can be performed at lower force or can be eliminated.

In one aspect, a method for cleaning a nozzle plate includes applying a first solution to a surface of the nozzle plate, and applying a second solution different from the first solution to the surface of nozzle plate to remove the first solution from the surface of nozzle plate. The first solution wets the nozzle plate and is a solvent to dried ink deposited on the surface of the nozzle plate. The surface of the nozzle plate is non-wetting to the second solution.

Implementations can include one or more of the following features. The second solution may be applied at an angle ≠0 with respect to a normal of the surface of the nozzle plate. A component of a momentum of the second solution may be in the plane of the surface of the nozzle plate and the first solution may be removed from the surface of the nozzle plate by the momentum imparted by the second solution. The component of the momentum of the second solution may remove debris from the surface of the nozzle plate. The second solution may be miscible with the first solution and may form a mixture solution comprising the first solution, the second solution and the dissolved dried ink. The mixture solution may not wet the surface of the nozzle plate. The surface of the nozzle plate may be contacted with a first surface after the first solution is applied to the surface of the nozzle plate. The second solution the second solution may be more non-wetting than the mixture solution. The second solution may be a high polarity high surface energy fluid. The second solution may be deionized water. The surface of the nozzle plate may be contacted with a first surface while the first solution is applied to the surface of the nozzle plate. The first surface may include an element selected from a group consisting of: a brush, a piece of cloth, a piece of leather, a sharp blade, a sponge and an open cell foam. The first surface may be used to apply a shearing force to debris deposited on the surface of the nozzle plate. A blade of air may be used to remove second solution from the surface of the nozzle plate. Applying a second solution may include contacting the nozzle plate with a jet of the second solution and causing relative motion between the nozzle plate and the jet. The surface of the nozzle may include a coating that is non-wetting to the ink.

In another aspect, an apparatus may include a printbar having a surface with a plurality nozzles, and a maintenance station. The maintenance station has a washing station include a first plurality of outlets that directs a first solution towards the printbar, and a rinsing station comprising a second plurality of outlets that directs a second solution at an oblique angle to the surface of the printbar.

Implementations can include one or more of the following features. A wiping station may include an element configured to apply a mechanical force to a surface of the printbar. The element may be selected from a group consisting of a brush, a piece of cloth, a piece of leather, a sharp blade, a sponge and an open cell foam. The washing station may include an element integrated with the plurality of outlets to apply a mechanical force to the printbar while the plurality of outlets direct the first solution towards the printbar. The element may be selected from a group consisting of a brush, a piece of cloth, a piece of leather, a sharp blade, an air blade, a sponge and an open cell foam. The maintenance station may be configured to be selectively advanced to a position under the printbar prior to activating the washing station and rinsing station, and the maintenance station may be configured to be selectively retracted from under the printbar upon deactivation of the washing station and rinsing station. The printbar may include a printhead module having a nozzle plate, and a surface of the nozzle plate may include a non-wetting coating. The first solution may be a cleaning solution that dissolves dried ink on the surface of the nozzle plate and the second solution may be a high polarity, high surface energy fluid with respect to the non-wetting coating. The second solution may be deionized water. An element may be configured to remove debris from the surface of the nozzle plate while the first solution is directed to the surface of the nozzle plate. The element may be an irrigated sponge. The element is a brush comprising a plurality of segments of bristles. A device may be configured to hold the printbar with the surface at an oblique angle relative to gravity.

These and other features and aspects, and combinations of them, can be expressed as systems, components, apparatus, methods, means or steps for performing functions, and in other ways.

Other features, aspects, implementations, and advantages will be apparent from the description and the claims.

### DESCRIPTION OF DRAWINGS

FIGS. 1A and 1B are a schematic system side-views of the printing apparatus and the maintenance station.

FIG. 2A is a schematic perspective view of a nozzle plate.

FIGS. 2B and 2C are schematic side views of a non-wetting liquid and a wetting liquid, respectively, on a nozzle plate.

FIG. 2D is a schematic side view of a droplet of liquid on a tilted nozzle plate.

FIG. 2E is a schematic perspective view of a nozzle plate having debris.

FIG. 2F is a schematic side view of a system in which a rinsing solution is directed at an angle onto a nozzle plate.

FIGS. 3A-3C are pictures of a nozzle plate after different cleaning steps.

FIGS. 4A-4G are schematic side views of various implementations of a maintenance station.

FIGS. 5A and 5B illustrate a shearing force applied by the maintenance station to remove debris from the nozzle plate.

Like reference symbols in the various drawings indicate like elements.

### DETAILED DESCRIPTION

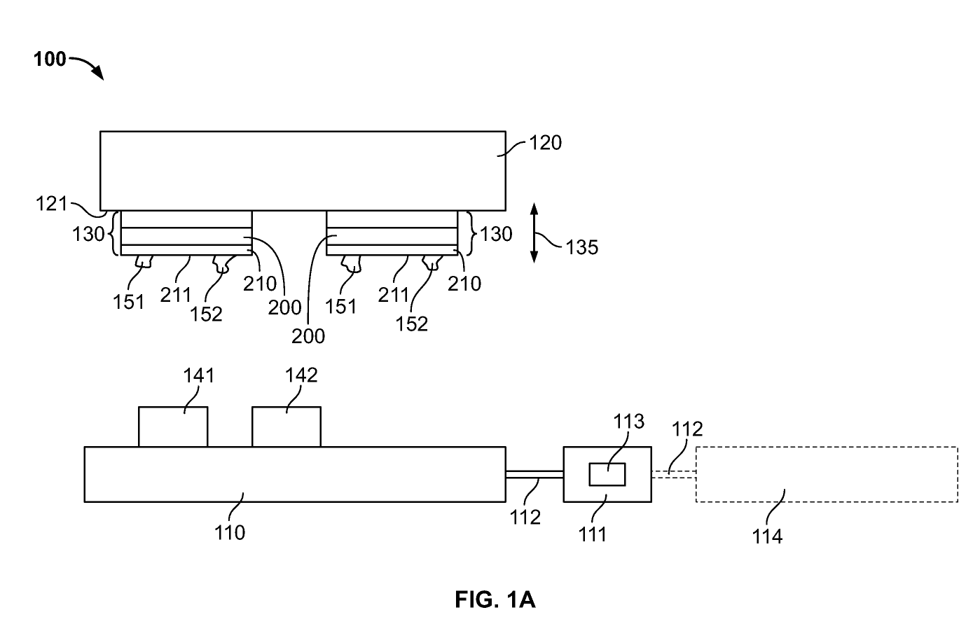

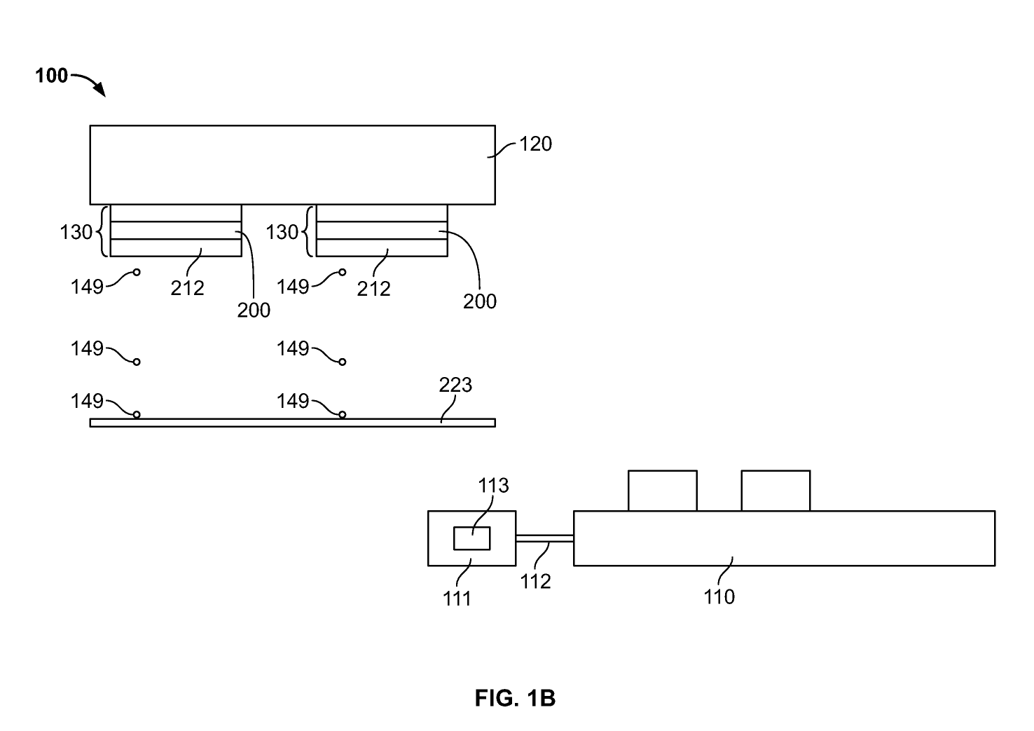

FIGS. 1A and 1B show a printing apparatus 100 and a movable maintenance station 110. Printing apparatus 100 includes a printbar 120 onto which at least one printhead module 130 is mounted. A protrusion 135 of the printhead module 130 from the printbar 120 is exaggerated and is not drawn to scale. In some figures, only the printbar 120 is illustrated, but it should be understood that the printbar 120 contains printhead modules 130 each having an exposed surface 211 that is mounted parallel to a layer surface 121 of the printbar. Each printhead module can include a nozzle plate 200. A non-wetting coating 210 can be formed on the nozzle plate 200. The exposed surface 211 can be the outer surface of the non-wetting coating 210, or the outer surface of the nozzle plate 200 if the non-wetting coating 210 is absent. The non-wetting layer 210 can be a monolayer formed from a precursor vapor that includes 1H,1H,2H,2H perfluorodecyltrichlorosilane (FDTS). Alternatively the non-wetting layer 210 can be a molecular aggregation formed from a similar precursor vapor, or can be another non-wetting coating, e.g., a fluorocarbon polymer such as Teflon.

A controller 111 having a drive mechanism 112 moves the movable maintenance station 110 under the printbar 120 when maintenance to be performed on the printing apparatus 100. The maintenance station 110 includes substations 141 and 142 which contain cleaning solutions and wiping tools. The maintenance station 110 can be used, for example, to remove adhered ink and other debris collected at the exposed face 211 of the printhead module 130.

The maintenance station 110 may be deployed by the controller 111 after a set period of time, for example, a set number of hours of run-time of the printing apparatus 100, or after a set number of sheets have been printed. The maintenance station 110 may also be deployed after an optical detector 113 detects a problem with the jetting process due to the buildup of adhered ink and debris on the nozzle plate caused by the generation of ink mist during the jetting process. When the maintenance station 110 is not being deplored, the drive mechanism 112 retracts the maintenance station to a storage position 114. Alternatively, the maintenance station can be stationary and the print bar can be moved to the maintenance station after a printing operation is completed.

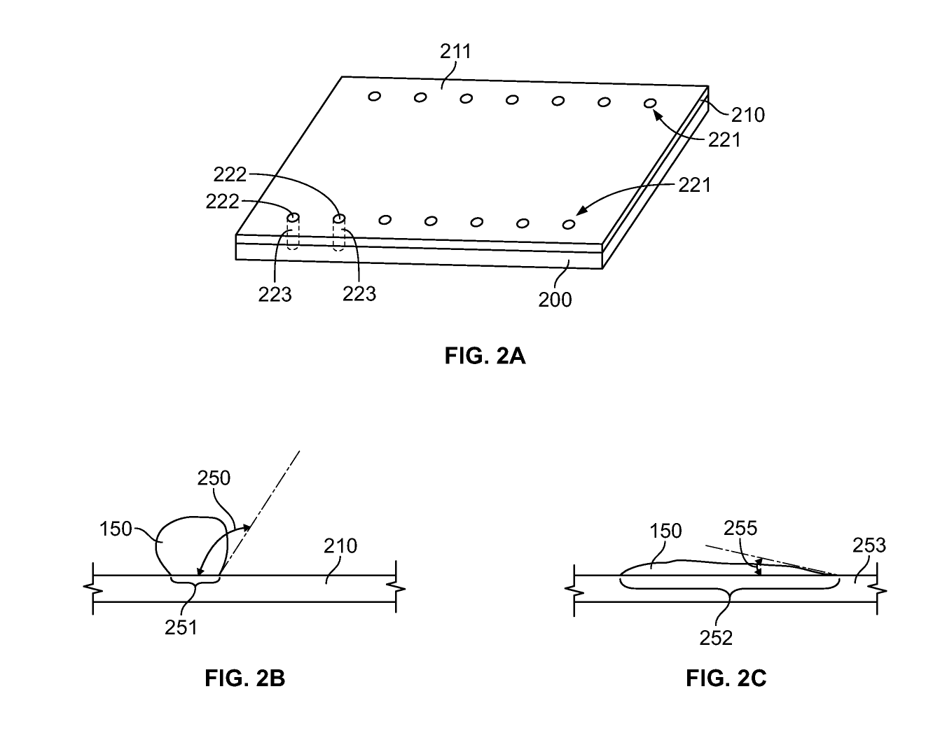

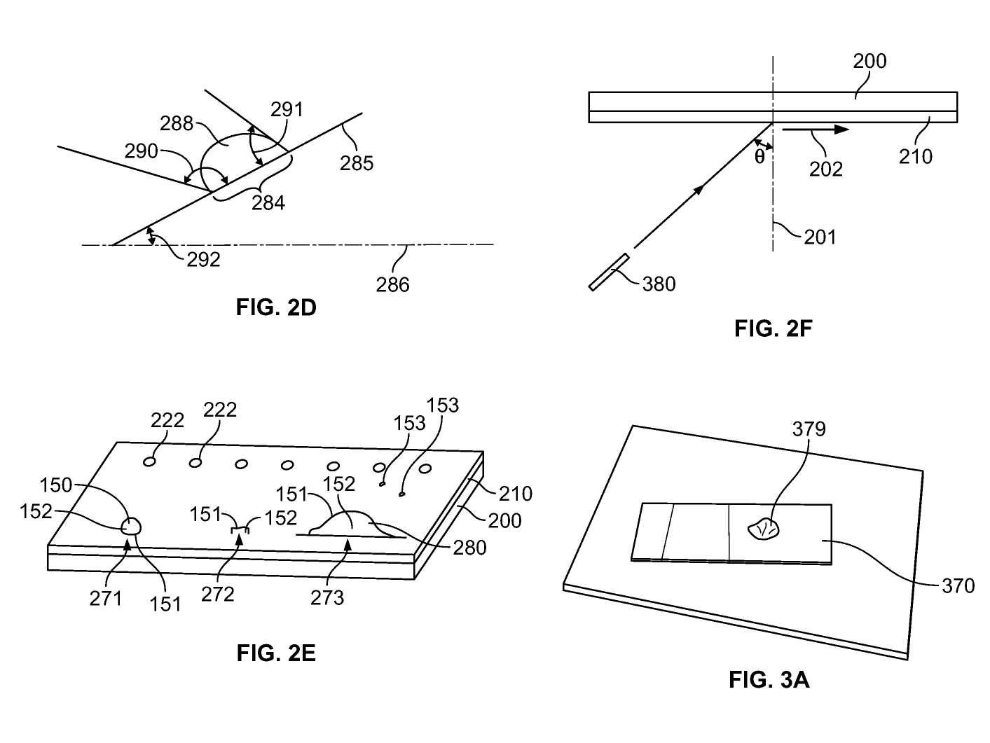

The nozzle plate 200 is the outermost component of the printhead module 130 and the nozzle plate 200 has an exposed surface 211 in which one or more rows 221 of nozzle openings 222 are defined (see FIG. 2A where two rows are illustrated, but there could be just one row). The nozzle openings 222 define the end of nozzles apertures 223 that extend through the nozzle plate 200. The non-wetting layer 210 includes apertures aligned with the openings 222 so that the non-wetting layer 210 does not obstruct the nozzle openings 222. The printhead module 130 includes pumping chambers, piezoelectric elements (not illustrated in FIGS. 1A and 1B) that are associated with each of the nozzle openings 222 defined in the nozzle plate 210. The exposed surface 211 of the nozzle plate 200 faces a medium 223 onto which ink droplets 149 of an ink 150 from the printhead module 130 are jetted (see FIG. 1B). FIG. 2A shows a bottom-up view of the nozzle plate 200 having the non-wetting layer 210 coating on its exposed surface 211.

In general, the non-wetting layer 210 is a surface having a smaller surface energy compared to the surface tension of a liquid (e.g., the ink 150) that will be jetted from the printhead module 130. As a result of the smaller surface energy of the non-wetting layer, a drop of the liquid (e.g., the ink 150) forms a static contact angle 250 at a liquid/surface interface 251 that is larger than 90 degrees, as shown in FIG. 2B. The surface tension of a liquid is determined by the forces of attraction between molecules of that liquid. A wetting surface 253 (shown in FIG. 2C) has a large enough surface energy to overcome the surface tension forces that hold the molecules of the liquid together, as a result, the liquid (e.g., the ink 150) forms a static contact angle 255 at a liquid/surface interface 252 that is smaller than 90 degrees (i.e., the liquid spreads and wets the wetting surface 253). For example, the forces between the hydrocarbon molecules that make up the polymers are weak and consequently polar liquids tend to form droplets on a polymeric surface rather than spread out.

Dynamic contact angles of liquid can be used to characterize a liquid that moves along a liquid-surface interface. FIG. 2D shows a surface 285 on which a liquid-surface interface 284 of a liquid droplet 288 is formed. When the surface 285 makes an angle with respect to a horizontal plane 286, the angle 292 at which the liquid droplet 288 starts moving is related to the dynamic contact angles which include an advancing angle 290 and a receding angle 291 of the liquid droplet 288. A liquid droplet 288 that slides easily off the surface 285 has a small value for the angle 292. Static and dynamic contact angles are not necessarily related.

In general, the ink 150 can be broadly considered to include a solvent 151 in which a pigment 152 is dissolved or suspended, as depicted in an area 271 shown in FIG. 2E. Notwithstanding the presence of the non-wetting layer 210, pigment 152 may adhere to the non-wetting layer 210 (shown in an area 272 of FIG. 2E) as dried ink or debris after the solvent 151 in the ink 150 has evaporated, for example, when the printhead 130 is mounted in such a way that the nozzle plate 200 is held horizontally. The adhered dry ink (that is, the pigment 152) can be removed by washing the exposed surface 211 of the nozzle plate 200 using a cleaning solution 280 that is a solvent for the pigment 152 (shown in an area 273 of FIG. 2E). The cleaning solution should also be miscible with whatever residual solvent 151 there might remain in the adhered dry ink. In addition, the cleaning solution should have a lower surface tension than the surface tension of the non-wetting layer 210. Thus, the cleaning solution itself, or when mixed with any solvent 151 that remains on the exposed surface 211, is wetting to the non-wetting layer 210. The cleaning solution can have a sufficiently low surface tension that the cleaning solution 280 spreads over the surface and wets the non-wetting layer 210, ensuring more thorough cleansing.

Any other debris 153 that is not re-solvated by the cleaning solution 280 can be mechanically removed from the nozzle plate 200, for example, by a brush or by wiping. The cleaning solution 280 can be applied using a fountain 143 in a washing substation 143 on the maintenance station 110 (see FIG. 1A).

The substation 142 in the maintenance station 100 may be a wiping station that is used to simultaneously i) remove the cleaning solution 280 that wets the non-wetting layer 210 from the exposed surface 211 and to ii) mechanically remove any debris 153 that may be present. However, mechanical wiping can result in directionality errors in the printhead module 130 that are dependent on the wiping direction. For example, without being limited to any particular theory, the wiping direction may have an effect on jetting direction of ink droplet from the printhead module 130 due to inadvertent packing of debris 153 into nozzle openings 222, or residual cleaning solution 280 may still accumulate around the nozzle opening 222 on the nozzle plate 200 and deviate ink droplets 149 jetted from the printhead module 130 from their original trajectories in the absence of the residual cleaning solution 280.

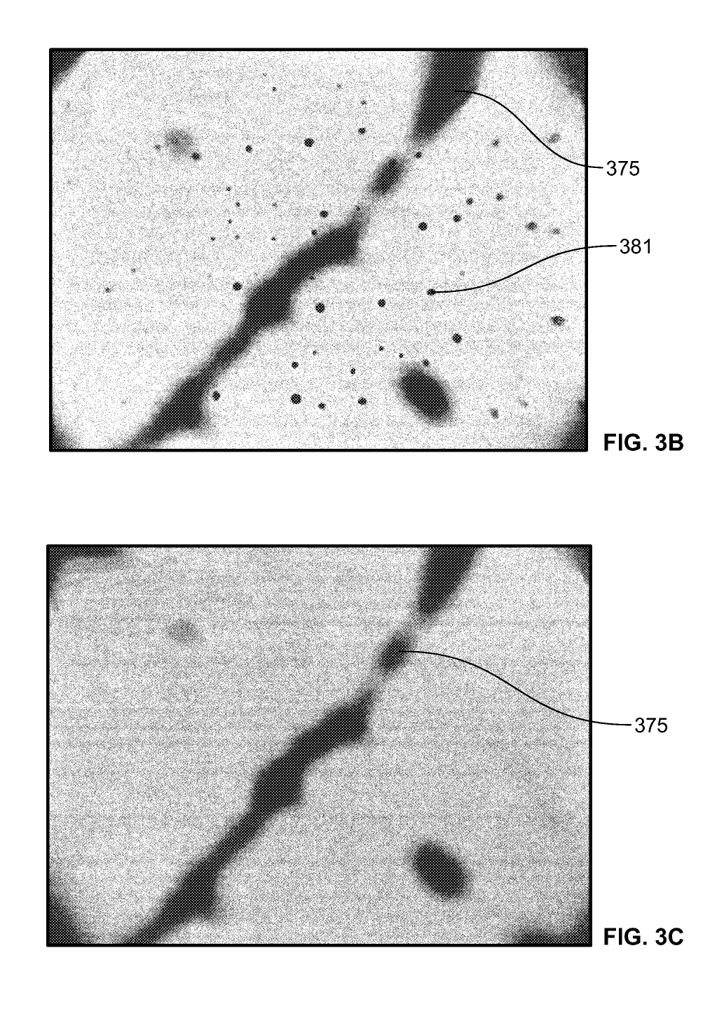

In addition, excessive wiping may damage the non-wetting layer 210. The high forces required to perform both tasks (removing the wetting cleaning solution 280 from the non-wetting layer 210 and removing debris 153) simultaneously can cause substantial abrasion to the non-wetting layer 210. The high forces can also increase the chance that debris 153 may get inadvertently pushed into nozzle openings 222, rendering that particular nozzle inoperable. Finally, the removal of the cleaning solution 280 from the non-wetting layer 210 may not be complete. For example, FIG. 3A shows a drop 379 of the cleaning solution 280 on a glass slide 370 having a non-wetting layer 210 coated thereon. FIG. 3B shows small droplets 381 of residual cleaning solution 280 that remain on the glass slide 370 after wiping. A mark 375 is made on the glass slide 370 for identifying the position of the drop 379 of cleaning solution 280.

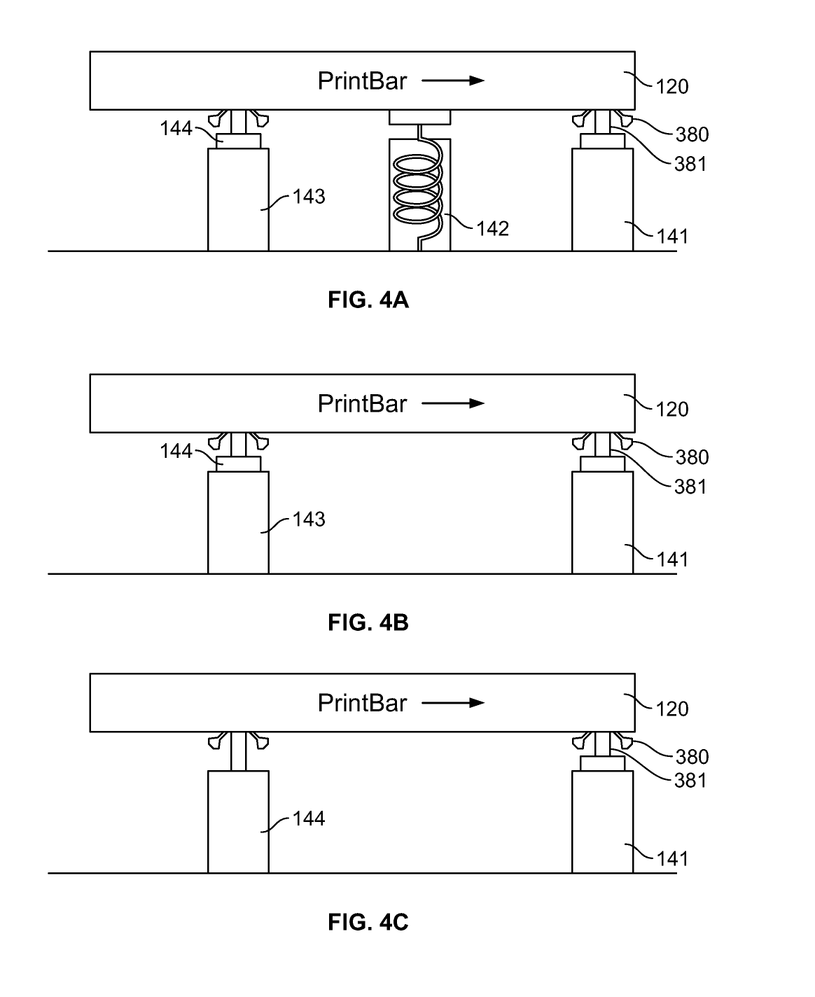

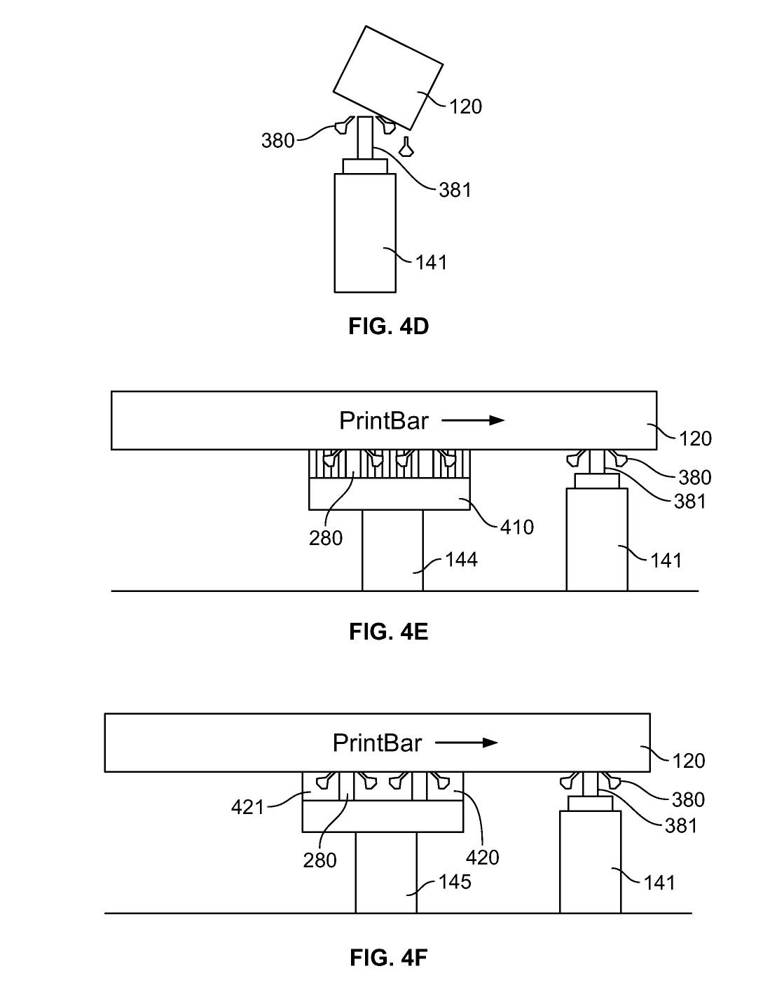

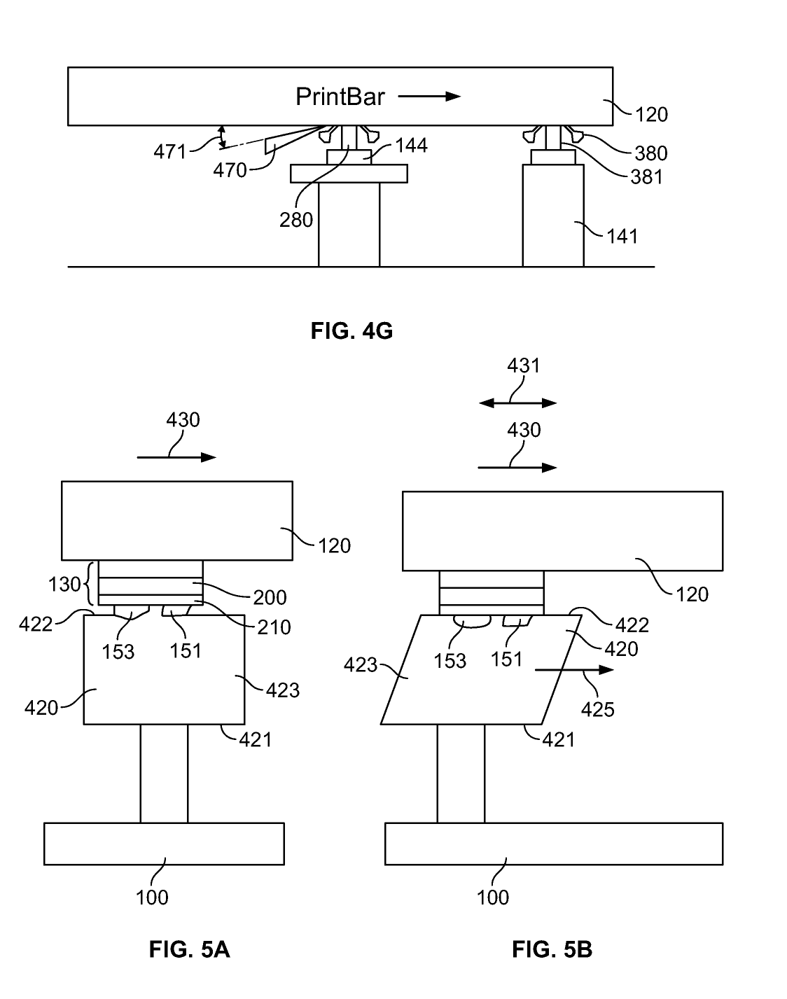

As shown in FIG. 4A, instead of using a single wiping station 142 that mechanically removes both the debris 153 and the cleaning solution 280, an additional substation 141 that functions as a rinsing station is included in the maintenance station 110. The rinsing station applies a flow of high polarity, high surface energy rinsing solution 380 through a fountain 381. A high polarity fluid typically has a high dielectric constant (e.g., more than 15). A high polarity fluid dissolves other polar substances well. The rinsing solution 380 is non-wetting to the non-wetting layer 210. The rinsing solution 380 has a low dynamic wetting angle.

Without being limited to any particular theory, the rinsing solution 380 can mix with the cleaning solution 280, leaving a mixture that is more non-wetting, and thus easier to remove from the external surface 211. Since the mixture is easier to remove, wiping forces can be reduced, the danger of damage to the non-wetting coating 120 can be reduced, and the useful lifetime of the device can be increased.

A glancing flow of the rinsing solution can be applied to the nozzle plate 200. As shown in FIGS. 2F and 4D, a glancing flow makes an angle 0 from a normal 201 of the nozzle plate 200. The use of a glancing flow imparts a component of velocity of the fluid stream, denoted by the arrow 202, in the plane of the nozzle plate 200. The glancing flow can result from either directing the rinsing solution 380 at an angle to a horizontally held nozzle plate 200 as shown in FIG. 2F, or the nozzle plate 200 or the printbar 120 can be misaligned from a horizontal position as shown in FIG. 4D. Small rotational adjustments can be applied to orient the printbar 120 to the optimal angle for rinsing and removal of the cleaning and rinsing solutions 280 and 380.

The use of a glancing flow of fluid also allows the advancing dynamic contact angle to be achieved more easily, easing the flow of the rinsing liquid 380, which is miscible with the cleaning solution 280, from the non-wetting layer 210 of the nozzle plate 200. In this way, minimal mechanical wiping is required to remove the cleaning solution 280 from the nozzle plate 200. FIG. 3C shows the removal of all small droplets 381 of cleaning solution 280 after the rinsing solution 380 is used, a marked improvement from the situation shown in FIG. 3B. The wiping station 142 can then be dedicated to the removal of debris 153, using smaller wiping forces than would be required if both debris and the cleaning solution 280 were to be actively removed from the nozzle plate 200. An example of a suitable high polarity, high surface energy fluid is deionized water (DI). In some cases, the wiping station 142 can be eliminated, as shown in FIG. 4B, in which the maintenance station 110 includes only a washing station 143 and the rinsing station 141.

The separation of the removal of debris 153 from the removal of the cleaning solution 280 permits more methods to be used for wiping or scrubbing debris off the nozzle plate 280. For example, a brush having either synthetic or natural bristles, cloth strips, or strips of pliable leather, such as Chamoix or synthetic Chamoix, can be used in either a lateral (i.e. linear) scrubbing motion, a rotary scrubbing motion or a combination of lateral and rotary scrubbing motion can be used instead of being restricted to the use of a cloth (the latter is suitable for the removal of cleaning solution 280). The brush can include brush segments that work in concert or in sequence with one another. One segment of the brush may have finer bristles than another segment, and the motion of the brushes in different segments may vary in terms of direction, type of motion or the speed of motion relative to the nozzle plate 200.

The cleaning solution 280 can be applied through or within a brush 410, as shown in FIG. 4E by combining these two functions into a single station 144 (see FIGS. 4C and 4E). In this way, the contact time between the nozzle plate 200 and the cleaning solution 280 can be substantially longer because the brush keeps the cleaning solution in contact with the nozzle plate longer than a fountain alone does, increasing the efficacy of re-dissolving the dried ink pigments 151 that adheres to the non-wetting layer 210. Alternatively, a shorter amount of time is required to re-dissolve a fixed amount of dried ink pigments 151.

Besides using a brush, an irrigated sponge 420 can also be used. A soft, open-cell-structured foam or sponge material 421 through which the cleaning solution 280 is pumped can be placed in contact with the nozzle plate 200. Open-cell-structured foams contain pores that are connected to one another and form an interconnected network that is relatively soft. Open-cell foams fill easily with materials they are surrounded with (e.g., the cleaning solution 280). Foam rubber is a type of open-cell foam. The irrigated sponge can be driven in a linear or rotary fashion about the nozzle plate 280. A stiff sponge 423 can be driven with enough force to create enough friction forces between the sponge and the nozzle plate for the sponge to be pinned to the nozzle plate. A shearing force 425 (shown in FIG. 5B) can then be applied to the adhered dried ink pigments 151 effectively without generating undue relative motion between the irrigated sponge and the non-wetting layer 210 to cause the delamination of the layer 210.

FIG. 5A shows an example of how shearing forces help to remove adhered dried ink pigments 151 or debris 153 without increasing the chance of a delamination of the non-wetting layer 210. An irrigated sponge scrubber 420 is held stationary while the printbar 120 is driven in the direction indicated by an arrow 430. A bottom surface 421 of the irrigated sponge scrubber is held stationary, and the shearing force generated by the stiff sponge 423 causes the top surface to move with the advancing printbar 120, deforming the sponge 423. Due to the closer proximity of the adhered dried ink pigments 151 and the debris 153 to the sponge 423, a larger force is applied to the adhered dried ink 151 and the debris 153, enabling them to be dislodged from the non-wetting layer 210. The non-wetting layer 210 does not delaminate from the nozzle plate 200 because a smaller force is applied by the shearing force from the sponge 423 on it than on the dried ink pigments 151 and the debris 153. The printbar 120 can also be driven to oscillate linearly in the direction as indicated by a double head arrow 431 while the irrigated sponge scrubber 420 is kept stationary.

Alternatively, the printbar 120 can be held stationary while the irrigated sponge scrubber 420 is oscillated back and forth. In this case, is the top surface 422 would be held stationary while the sponge is being deformed and the bottom surface 421 would shear.

The use of irrigated sponge 420 may also help to keep the cleaning solution 280 on the exposed surface 211 of the nozzle plate 200 for a longer period of time than if the fountain 144 were used alone. Chances of scratching the non-wetting layer 210 is reduced when the layer 210 is exposed to a sufficient amount of cleaning solution 280 while mechanical motion by way of either the brush 410 or the sponge 420 is applied to the non-wetting layer 210. In this way, mechanical forces can be applied to the non-wetting layer 210 without damaging the surface.

FIG. 4G shows a shaped, flexible blade 470 oriented at a small angle 471 with respect to the nozzle plate 200 in the printbar 120—can also be used in place of the brush 410 or sponge 420. The cleaning solution 280 can be used to re-dissolved dried ink pigments 151 and the flexible blade 470 can then be used to sever or push re-dissolved adhered ink pigments 151 from the nozzle plate 280. The rinsing solution 380 can be subsequently used to clean the nozzle plate 280.

Although the implementations above describe inks with solvents, the ink need not include a solvent, but can still be soluble to another type of liquid. For example, some UV inks do not have solvents in them, but are soluble. In addition, if the rinsing fluid has sufficiently high energy, it may be possible to have a nozzle plate surface that is not non-wetting to the ink, e.g., a surface without a non-wetting coating. For example, with a silicon nozzle plate, the silicon will grow a native oxide layer that is neither wetting nor non-wetting but instead influenced by what it has touched recently. By using a high energy rinsing fluid, ink can still be removed from a surface that is not non-wetting to the ink, e.g., from a native oxide surface of a silicon body.

Other implementations are also within the following claims.

What is claimed is:

1. A method for cleaning a nozzle plate, comprising:
applying a first solution to a surface of the nozzle plate, wherein the first solution wets the nozzle plate and is a solvent to dried ink deposited on the surface of the nozzle plate; and
applying a second solution different from the first solution to the surface of nozzle plate to remove the first solution from the surface of nozzle plate,
wherein the surface of the nozzle plate is non-wetting to the second solution.

2. The method of claim 1, wherein the second solution is applied at an angle α≠0 with respect to a normal of the surface of the nozzle plate.

3. The method of claim 1, wherein the second solution is miscible with the first solution and forms a mixture solution comprising the first solution, the second solution and the dissolved dried ink, the mixture solution does not wet the surface of the nozzle plate.

4. The method of claim 1, wherein the second solution the second solution is more non-wetting than the mixture solution.

5. The method of claim 1, wherein the second solution is a high polarity high surface energy fluid.

6. The method of claim 1, comprising contacting the surface of the nozzle plate with a first surface while the first solution is applied to the surface of the nozzle plate.

7. The method of claim 6, wherein the first surface comprises an element selected from a group consisting of: a brush, a piece of cloth, a piece of leather, a sharp blade, a sponge and an open cell foam.

8. The method of claim 6, comprising using the first surface to apply a shearing force to debris deposited on the surface of the nozzle plate.

9. The method of claim 1, comprising removing the second solution from the surface of the nozzle plate with an air blade.

10. The method of claim 1, wherein applying a second solution comprises contacting the nozzle plate with a jet of the second solution and causing relative motion between the nozzle plate and the jet.

11. An apparatus, comprising:
a printbar having a surface with a plurality nozzles; and
a maintenance station, comprising:
a washing station comprising a first plurality of outlets that directs a first solution towards the printbar; and
a rinsing station comprising a second plurality of outlets that directs a second solution at an oblique angle to the surface of the printbar.

12. The apparatus of claim 11, comprising a wiping station comprising an element configured to apply a mechanical force to a surface of the printbar.

13. The apparatus of claim 12, wherein the element is selected from a group consisting of a brush, a piece of cloth, a piece of leather, a sharp blade, a sponge and an open cell foam.

14. The apparatus of claim 11, wherein the washing station further comprises an element integrated with the plurality of outlets to apply a mechanical force to the printbar while the plurality of outlets direct the first solution towards the printbar.

15. The apparatus of claim 14, wherein the element is selected from a group consisting of a brush, a piece of cloth, a piece of leather, a sharp blade, an air blade, a sponge and an open cell foam.

16. The apparatus of claim 11, wherein the maintenance station is configured to be selectively advanced to a position under the printbar prior to activating the washing station and rinsing station, and the maintenance station is configured to be selectively retracted from under the printbar upon deactivation of the washing station and rinsing station.

17. The apparatus of claim 11, wherein the printbar comprises a printhead module having a nozzle plate, a surface of the nozzle plate comprising a non-wetting coating.

18. The apparatus of claim 17, wherein the first solution is a cleaning solution that dissolves dried ink on the surface of the nozzle plate and the second solution is a high polarity, high surface energy fluid with respect to the non-wetting coating.

19. The apparatus of claim 18, comprising an element configured to remove debris from the surface of the nozzle plate while the first solution is directed to the surface of the nozzle plate.

20. The apparatus of claim 11, comprising a device configured to hold the printbar with the surface at an oblique angle relative to gravity.
